(19) United States
(12) Patent Application Publication
(10) Pub. No.: US 2025/0234289 A1
(43) Pub. Date: Jul. 17, 2025

(54) SYSTEMS AND METHODS FOR ENERGY POLICY ENFORCEMENT ON A PER SERVICE BASIS

(71) Applicant: HFCL Limited, Bangalore (IN)

(72) Inventors: Subhas Chandra Mondal, Bangalore (IN); Valluri Satyanarayana Murthy, Bangalore (IN)

(21) Appl. No.: 19/023,492

(22) Filed: Jan. 16, 2025

(30) Foreign Application Priority Data
Jan. 16, 2024 (IN) 202441003112

(51) Int. Cl. H04W 52/02

(52) U.S. Cl. CPC H04W 52/0206

(57) ABSTRACT

Systems and methods for energy policy enforcement on a per service basis are described. In particular, the method includes receiving (302) a set of network-monitored power parameters from a base station (112-1) in an access network, the set of network-monitored power parameters corresponding to a service associated with a user equipment served by the base station (112-1) in the access network. Further, the method includes determining (304) a power policy corresponding to the service associated with the user equipment based at least on the set of network-monitored power parameters, and transmitting (306), via one or more network entities of a core network (102), the power policy to the base station (112-1) for enforcement of the power policy at the base station (112-1).

### CROSS REFERENCE TO RELATED APPLICATIONS

The present application claims the benefit of Indian Patent Application number 202441003112 filed on Jan. 16, 2024, the contents of which are incorporated herein by reference in their entirety.

### TECHNICAL FIELD

The present disclosure, in general, relates to energy optimization in a wireless communication network, and in particular, relates to energy policy enforcement on a per service basis.

### BACKGROUND

Energy efficiency is a key parameter in 5G and upcoming 6G technologies. While there are available mechanisms on energy management at a network node or a device level, there is a need to have a system and a method for computing energy consumption on a per service basis. There is no known system or method for determining the energy consumption at the service level.

In a wireless network, the network and the user equipment together provide the network services like voice service and data service to the end user. Hence, the total energy consumption at a service level involves energy consumed at the network and energy consumed at the user equipment. Further, at the network side, the total energy consumption can be calculated based on energy consumed by the base station, core network, and message exchanges between them. A major part of the mobile network's energy is consumed by the base station. Therefore, it is important to optimize the energy of the base station for reducing end-to-end energy consumption.

As an example, a voice service may either be in an inactive phase while the user equipment is in an idle mode or a switched-off mode. When the user equipment is switched on, the user equipment is attached to the network by spending some energy for exchanging control information. Once the user equipment is in attached state, the network can provide voice services for both, network originated, or user equipment originated voice call request. There will be energy spent during the setup phase, active phase, and termination phase. Currently, there is no known method to estimate and adaptively control the amount of energy required, for example, by the base station, to deliver the services in each phase of the service for different users with different subscription levels.

Therefore, there is a need for an efficient mechanism to identify and enforce a power management policy at a base station for optimizing the overall energy consumption of the network and providing a service to a user equipment.

### OBJECTS OF THE PRESENT DISCLOSURE

It is an object of the present disclosure to provide an efficient solution for energy policy enforcement at a base station for providing a service to a user equipment.

It is an object of the present disclosure to provide an efficient solution for service-based optimization of base station based on resource utilization.

It is an object of the present disclosure to provide an energy optimization function for a base station for providing a service to a user equipment.

### SUMMARY

In an aspect, the present disclosure relates to a method for power policy enforcement in an access network, including receiving, by a processor associated with a core network, a set of network-monitored power parameters from a base station in the access network, the set of network-monitored power parameters corresponding to a service associated with a user equipment served by the base station in the access network, determining, by the processor, a power policy corresponding to the service associated with the user equipment based at least on the set of network-monitored power parameters, and transmitting, by the processor, via one or more network entities of the core network, the power policy to the base station for enforcement of the power policy at the base station.

In an embodiment, determining, by the processor, the power policy may include determining, by the processor, the power policy further based on historical power parameters, workload, and user subscription level corresponding to the user equipment.

In an embodiment, receiving, by the processor, the set of network-monitored power parameters comprises receiving, by the processor, the set of network-monitored power parameters via one of: Network Configuration (NETCONF) protocol-based interface, or HyperText Transfer Protocol Secure (HTTPs) protocol-based interface.

In an embodiment, the method may include receiving, by the processor, a trigger notification including an updated set of network-monitored power parameters from the base station, and dynamically updating, by the processor, the power policy based at least on the updated set of network-monitored power parameters.

In an embodiment, the method may include transmitting, by the processor, a request to the base station to obtain a maximum power consumption value and a minimum power consumption value by the base station for the service, wherein the request may include at least one of an identifier of the base station, and an identifier of the service, and receiving, by the processor, the maximum power consumption value and the minimum power consumption value from the base station for the service.

In an embodiment, the one or more network entities may include Access and Mobility Management Function (AMF) entity, Session Management Function (SMF) entity, and Policy Control Function (PCF) entity.

In an embodiment, the transmitting may include transmitting, by the processor, via the AMF entity, the power policy to the base station, wherein the method may include receiving, by the AMF entity, an acknowledgement for accommodating the service according to the power policy from the base station, or receiving, by the AMF entity, a negative acknowledgment from the base station.

In an embodiment, in case of the negative acknowledgement, the method may include determining, by the AMF entity, another base station for accommodating the service based on the power policy, and initiating, by the AMF entity, a handover of the user equipment from the base station to the another base station for the enforcement of the power policy at the another base station.

In an embodiment, determining, by the AMF entity, the another base station may include calculating, by the AMF entity, a power consumption value by each of a plurality of base stations in the access network for accommodating the service, wherein the power consumption value by said each of the plurality of base stations may be based on at least one of a rated power of a given base station, a maximum power consumption by the given base station for the service, and a power amplifier efficiency corresponding to the given base station, and assigning, by the AMF entity, the another base station for accommodating the service based at least on the power consumption value and a user subscription level corresponding to the user equipment.

In an embodiment, initiating, by the AMF entity, the handover of the user equipment from the base station to the another base station may include transmitting, by the AMF entity, the power policy corresponding to the service to the another base station, and receiving, by the AMF entity, an acknowledgement for accommodating the service according to the power policy from the another base station, or receiving, by the AMF entity, a negative acknowledgment from the another base station.

In an embodiment, the method may include receiving, by the processor, a request for the power policy from the SMF entity corresponding to the service, and transmitting, by the processor, the power policy to the SMF entity in response to the request based on an identifier of the base station, wherein the transmitting the power policy to the base station may include transmitting, by the processor, via the SMF entity, the power policy to the base station.

In an embodiment, the power policy may include at least one of an identifier of the power policy, an identifier of the base station, an identifier of the service, a user subscription level corresponding to the user equipment, and one or more power thresholds for the service.

In an embodiment, the set of network-monitored power parameters may include at least one of an identifier of the base station, an identifier of the service, a user subscription level corresponding to the user equipment, a maximum power consumption by the base station for the service, a minimum power consumption by the base station for the service, a class of the base station, a rated power of the base station, and a power amplifier efficiency corresponding to the base station.

In an embodiment, the power policy may include one or more power thresholds for the service, such that for the enforcement of the power policy at the base station, an estimated power consumption value for the service for a pre-defined time interval may be within the one or more power thresholds.

In another aspect, the present disclosure relates to a network entity in a core network for power policy enforcement, including a processor, and a memory operatively coupled with the processor, wherein the memory includes processor-executable instructions which, when executed, cause the processor to transmit a request for a power policy corresponding to a service associated with a user equipment in an access network to another network entity in the core network, receive the power policy corresponding to the service associated with the user equipment from the another network entity, the power policy being based at least on a set of network-monitored power parameters, determine a power consumption value by each of a plurality of base stations in the access network for accommodating the service based on the power policy, assign a base station of the plurality of base stations based at least on the power consumption value and a user subscription level corresponding to the user equipment, and transmit the power policy to the base station for enforcing the power policy.

In another aspect, the present disclosure relates to a network entity in a core network for power policy enforcement, including a processor, and a memory operatively coupled with the processor, wherein the memory includes processor-executable instructions which, when executed, cause the processor to transmit a request for a power policy corresponding to a service associated with a user equipment served by a base station in an access network to another network entity in the core network, receive the power policy corresponding to the service associated with the user equipment from the another network entity, the power policy being based at least on a set of network-monitored power parameters, transmit the power policy to the base station for enforcing the power policy, determine an update in the set of network-monitored power parameters corresponding to the service, and transmit the updated set of network-monitored power parameters to the another network entity for dynamically updating the power policy corresponding to the service.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary system architecture for implementing the proposed mechanism, in accordance with an embodiment of the present disclosure.

FIG. 2 illustrates an exemplary system architecture of an energy control function (ECF) entity, in accordance with an embodiment of the present disclosure.

FIGS. 3A and 3B illustrate flow charts of example methods for implementing the proposed mechanism, in accordance with embodiments of the present disclosure.

FIG. 4 illustrates a sequence flow diagram of an example method between a base station and an ECF entity, in accordance with an embodiment of the present disclosure.

FIG. 5 illustrates a sequence flow diagram of an example method between a base station and an ECF entity with a Network Configuration (NETCONF)-based session, in accordance with an embodiment of the present disclosure.

FIG. 6 illustrates a sequence flow diagram of an example method between a base station and an ECF entity with a HyperText Transfer Protocol Secure (HTTPs) protocol-based session, in accordance with an embodiment of the present disclosure.

FIG. 7 illustrates a sequence flow diagram of an example method between an Access and Mobility Management Function (AMF) entity and the ECF entity, in accordance with an embodiment of the present disclosure.

FIG. 8 illustrates a sequence flow diagram of an example method between a Session Management Function (SMF) entity and the ECF entity, in accordance with an embodiment of the present disclosure.

FIG. 9 illustrates a sequence flow diagram of an example method between a base station and an energy database manager, in accordance with an embodiment of the present disclosure.

FIG. 10 illustrates a sequence flow diagram of an example method of N2 handover, in accordance with an embodiment of the present disclosure.

FIG. 11 illustrates an example computer system in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

In the existing 5G architecture, there are several models for computation of power consumption of a base station. However, none of the existing models provides a mechanism for estimating and monitoring the energy consumed on a per service basis on the network side and enforcing an energy management policy by a core network to the associated base station.

Thus, the present disclosure provides a mechanism for determining a policy for a given service. The present disclosure further describes a method for enforcing policy on radio access network (RAN) devices (i.e., base stations) to enable an energy optimization function for a base station for providing a particular service to a user equipment considering power consumption, traffic load, etc. as key parameters.

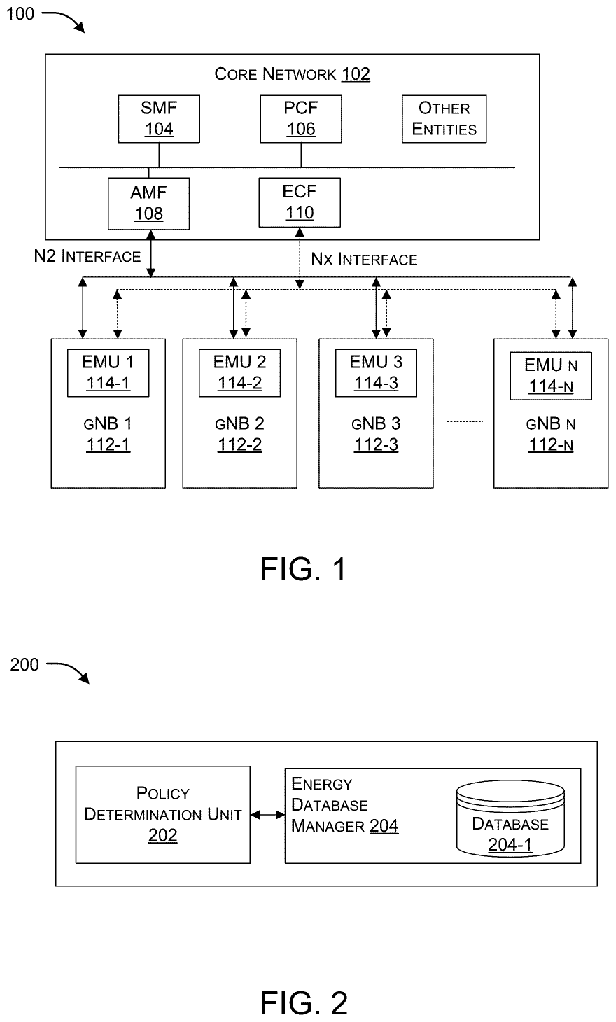

The various embodiments throughout the disclosure will be explained in more detail with reference to FIGS. 1-11.

FIG. 1 illustrates an exemplary system architecture 100 for implementing the proposed mechanism, in accordance with an embodiment of the present disclosure.

In particular, FIG. 1 shows a high-level system architecture 100 including a core network 102, for example, a 5G core network. The core network 102 includes one or more network entities such as, but not limited to, a Session Management Function (SMF) entity 104, a Policy Control Function (PCF) entity 106, an Access and Mobility Management Function (AMF) entity 108, an Energy Control Function (ECF) entity 110, and one or more other network entities. It may be appreciated that the terms “network entities” and “network functions” may be used interchangeably hereinafter.

The SMF entity 104 is responsible for establishing, maintaining, and terminating user sessions in the 5G core network 102. The SMF entity 104 manages user plane resources and interacts with User Plane Function (UPF) to ensure that data packets are correctly routed and forwarded.

The PCF entity 106 determines and controls policy rules for user services. The PCF entity 106 provides decision-making mechanism for policies like Quality of Service (QOS) rules, charging, and other service-specific behaviours.

The AMF entity 108 handles critical control plane functions like registration management, connection management, reachability management, mobility management, and access authentication. Referring to FIG. 1, the AMF entity 108 uses N2 interface for communication with one or more base stations (112-1, 112-2, 112-3 . . . 112-N), i.e., g Node B (gNB) in an access network, i.e. a Radio Access Network (RAN). It may be appreciated that the one or more base stations (112-1, 112-2, 112-3 . . . 112-N) may be collectively referred to as the base stations 112 and individually referred to as the base station 112.

The ECF entity 110 controls the total energy (i.e., power) consumed for a service by the base station 112. In some embodiments, the ECF entity 110 may reside in the core network 102, as shown in FIG. 1. In some other embodiments, the ECF entity 110 may reside in Service Management and Orchestration (SMO) in Open-Radio Access Network (O-RAN).

Referring to FIG. 1, an Energy Monitoring Unit (EMU) (114-1, 114-2, 114-3 . . . 114-N) may be dedicated to each base station 112. It may be appreciated that the EMUs (114-1, 114-2, 114-3 . . . 114-N) may be collectively referred to as the EMUs 114 and individually referred to as the EMU 114. The EMU 114 monitors real-time energy consumption on a per service basis and reports to the ECF entity 110 in the core network 102. In some embodiments, the EMU 114 uses a new interface, i.e., Nx interface to communicate with the ECF entity 110.

It may be appreciated that each network entity may include a processor, and a memory comprising processor-executable instructions that cause the processor to perform steps of methods discussed herein.

FIG. 2 illustrates an exemplary system architecture 200 of an ECF entity 110, in accordance with an embodiment of the present disclosure.

Referring to FIG. 2, the ECF entity 110 includes a policy determination unit 202 and an energy database manager 204. The energy database manager 204 includes a database 204-1. In some embodiments, the ECF entity 110 may include one or more processors such that a memory (or database 204-1) may include processor-executable instructions to be executed by the processor to cause the processor to perform the steps of the methods discussed herein.

The energy database manager 204 manages data collected from different base stations (e.g., 112) for each service and reports the data to the policy determination unit 202 to determine a policy for a corresponding base station 112 per service. The energy database manager 204 stores all the current and historical energy related parameters, workload, and service requirements of all the connected base stations 112 in its local database 204-1. The workload may refer to traffic, i.e., number of users or services provided by the base station 112. The service requirements may refer to QoS profile, or the like. Below Table 1 shows a format in which the energy database manager 204 stores the data.

TABLE 1

| | Service | Maximum | Minimum | gNB | Rated | PA |
|---|---|---|---|---|---|---|
| gNB ID | ID | Value | Value | class | Power | efficiency |
| A | 1 | 0011 | 0000 | 1 | 46 dBm | 30% |
| B | 24 | 1010 | 0001 | 2 | 38 dBm | 20% |
| C | 86 | 1111 | 0100 | 3 | 24 dBm | 25% |

In some embodiments, the policy determination unit 202 determines energy management policy or power policy per user per service based on the information in the energy database manager 204. In some embodiments, a power policy defines that, for a particular service, the energy or power consumed for a particular time interval must be less than or equal to a maximum power consumption value (i.e., upper threshold). In some other embodiments, the power consumed for a particular time interval must be less than or equal to the maximum power consumption value and must be greater than or equal to a minimum power consumption value (i.e., lower threshold). After policy determination is done, the same information is shared with other network entities of the core network 102 like SMF entity 104, AMF entity 108, etc. It may be appreciated that there may be more or fewer number of components in the ECF entity 110 within the scope of the present disclosure.

In some embodiments, the ECF entity 110 queries the energy database manager 204 using one or more power parameters of a service to get maximum and minimum power consumption value by the base station 112 for the service.

In some embodiments, after getting information from the energy database manager 204, the ECF entity 110 updates the PCF entity 106 by defining a new energy related policy. A policy decision may refer to a grouping of cohesive information elements describing a specific type of decision, e.g. QoS, charging data, etc. A policy decision may be linked to one or more Policy and Charging Control (PCC) rules or one or more session rules. A PCC rule or session rule may at most refer to one instance of the policy decision for each type.

With respect to policy enforcement, policy enforcement procedure starts with Packet Data Unit (PDU) session establishment request from a user equipment to an access network. Two different scenarios may be possible, after the PDU session request is sent from the user equipment to the access network. If the service is being activated for the first time, the access network may inform the EMU 114 to start monitoring energy consumption for a service. The EMU 114 may estimate energy consumed on a per service basis. The access network may follow the same call flow as described in 3GPP TS 23.502, clause 4.3.2 for session establishment. After the service is terminated, the access network may share the energy related parameters, i.e., the network-monitored power parameters to the ECF entity 110, as discussed herein. If the service is activated for the second instance, the energy consumption information is shared to the upper layers, a power policy is created at the ECF entity 110, and the power policy is shared to the access network.

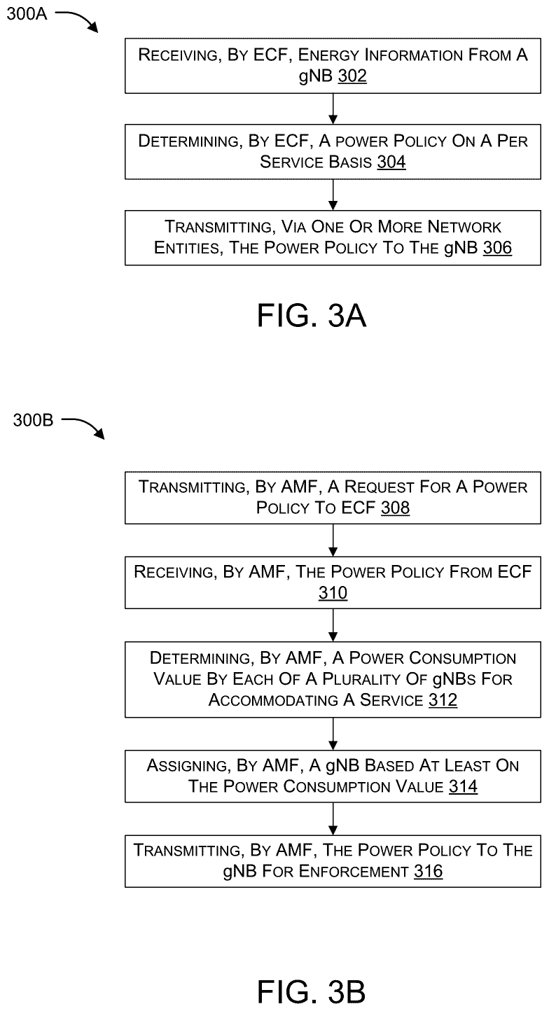

FIGS. 3A and 3B illustrate flow charts of example methods 300A, 300B for implementing the proposed mechanism, in accordance with embodiments of the present disclosure.

Referring to FIG. 3A, the method 300A may be implemented by the ECF entity 110.

At step 302, the method 300A may include receiving energy information from a base station (e.g., gNB 112). In some embodiments, the energy information may include at least a set of network-monitored power parameters corresponding to a service associated with a user equipment served by the base station 112. For example, the service may include, but not limited to, Voice over New Radio (VoNR) services, Internet services, real-time gaming services, Ultra Reliable Low Latency Communications (URLLC) services, and emergency services.

In some embodiments, the set of network-monitored power parameters may be received by the ECF entity 110 via the Nx interface, i.e. Network Configuration (NETCONF) protocol-based interface, or HyperText Transfer Protocol Secure (HTTPS) interface. In some embodiments, the set of network-monitored power parameters may include, but not limited to, an identifier of the base station 112, an identifier of the service, a user subscription level corresponding to the user equipment, a maximum power consumption by the base station 112 for the service, a minimum power consumption by the base station 112 for the service, a class of the base station 112, a rated power of the base station 112, and a power amplifier efficiency corresponding to the base station 112. Different classes of the base stations 112 are defined in 3rd Generation Partnership Project (3GPP) Technical Specification (TS) 38.104, clause 6.2.1 such as wide area, medium range, and local area. The rated carrier output power is defined in 3GPP TS 38.104, clause 6.2.1 for different classes of the base stations 112.

Referring to FIG. 3A, at step 304, the method 300A may include determining a power policy on a per service basis. The power policy may be determined by the ECF entity 110 (or the policy determination unit 202) corresponding to the service associated with the user equipment based on, but not limited to, the set of network-monitored power parameters, historical power parameters, workload (e.g., traffic which may be the number of users or services provided by the base station 112), a user subscription level corresponding to the user equipment, QoS profile, and other requirements corresponding to the service. In some embodiments, the power policy may include, but not limited to, an identifier of the power policy, an identifier of the base station 112, an identifier of the service, a user subscription level corresponding to the user equipment, and one or more power thresholds for the service. In some embodiments, the one or more power thresholds may include a maximum power threshold required for the service. In some other embodiments, the one or more power thresholds may include a minimum power threshold value required for the service, and a maximum power threshold value required for the service. It may be appreciated that there may be multiple levels of power threshold values in the power policy required for the service.

At step 306, the method 300A may include transmitting, via one or more network entities of the core network 102, the power policy to the base station 112 for enforcement of the power policy at the base station 112. In some embodiments, for the enforcement of the power policy, an estimated power consumption value for the service for a pre-defined time interval is within one or more power thresholds for the service, as defined by the power policy. As discussed with reference to FIG. 1, the one or more network entities may include the SMF entity 104, the PCF entity 106, and the AMF entity 108.

In some embodiments, the method 300A may include transmitting the power policy to the base station 112 via the AMF entity 108. The AMF entity 108 may receive an acknowledgement for accommodating the service according to the power policy from the base station 112. In some other embodiments, the method 300A may include receiving a negative acknowledgement from the base station 112.

In such scenarios, the AMF entity 108 may determine another base station (e.g., target base station 112-2) for accommodating the service based on the power policy. The AMF entity 108 may calculate a power consumption value by each of a plurality of base stations 112 in an access network for accommodating the service. In some embodiments, the power consumption value by each of the plurality of base stations 112 may be based on, but not limited to, a rated power of a given base station, a maximum power consumption by the given base station for the service, and a power amplifier efficiency corresponding to the given base station. The AMF entity 108 may then assign the target base station 112-2 for accommodating the service based on, but not limited to, the power consumption value and the user subscription level corresponding to the user equipment. Accordingly, the AMF entity 108 may initiate a handover of the user equipment from the base station 112 (i.e. source base station 112-1) to the target base station 112-2 for the enforcement of the power policy at the target base station 112-2. In some embodiments, the AMF entity 108 may transmit the power policy to the target base station 112-2, and receive an acknowledgement for accommodating the service according to the power policy from the target base station 112-2 or a negative acknowledgement from the target base station 112-2. In case of the negative acknowledgment, the AMF entity 108 may continue to calculate the power consumption value by the plurality of base stations 112 and assign another base station to accommodate the service according to the power policy.

In some embodiments, the method 300A may include transmitting the power policy to the base station 112 via the SMF entity 104. The ECF entity 110 may receive a request for the power policy from the SMF entity 104. The ECF entity 110 may transmit the power policy to the SMF entity 104 in response to the request based on an identifier of the base station 112. In some embodiments, the SMF entity 104 may determine an update in the set of network-monitored power parameters corresponding to the service, and transmit the updated set of network-monitored power parameters to the ECF entity 110 for dynamically updating the power policy corresponding to the service.

Referring to FIG. 3B, the method 300B may be implemented by the AMF entity 108. At step 308, the method 300B may include transmitting a request for a power policy corresponding to a service associated with a user equipment in an access network to another network entity, i.e. ECF entity 110 in the core network 102. At step 310, the method 300B may include receiving the power policy from the ECF entity 110.

Further, at step 312, the method 300B may include determining a power consumption value by a plurality of base stations 112 for accommodating the service based on the power policy. At step 314, the method 300B may include assigning a base station (e.g., 112-1) based on, but not limited to, the power consumption value and a user subscription level corresponding to the user equipment. At step 316, the method 300B may include transmitting the power policy to the base station 112-1 for enforcing the power policy.

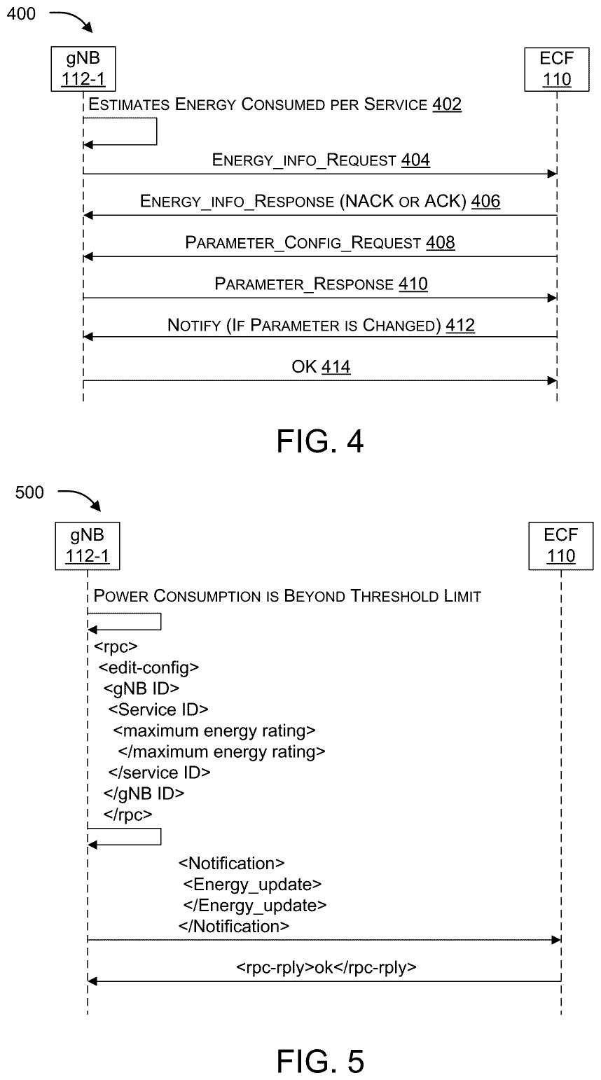

FIG. 4 illustrates a sequence flow diagram of an example method 400 between a base station 112-1 and an ECF entity 110, in accordance with an embodiment of the present disclosure.

Referring to FIG. 4, at step 402, the base station 112-1 estimates energy or power consumed per service. At step 404, an energy information request is sent from the base station 112-1 to the ECF entity 110. At step 406, an energy information response is received by the base station 112-1 from the ECF entity 110.

Further, at step 408, a parameter configuration request is sent by the ECF entity 110 to the base station 112-1. At step 410, a parameter response including a set of network-monitored power parameters is sent by the base station 112-1 to the ECF entity 110 to facilitate the ECF entity 110 to determine a power policy corresponding to the service. The parameters may be transferred from the base station 112-1 to upper layers, i.e. core network 102 for every service which the base station 112-1 may have offered.

At step 412, the ECF entity 110 may request the base station 112-1 to notify the ECF entity 110 in case any network-monitored parameter is changed. At step 414, the base station 112-1 ECF acknowledges the request, and confirms to notify the ECF entity 110 in case of any change in the network-monitored parameters.

In some embodiments, as discussed herein, the set of network-monitored power parameters may include, but not limited to, an identifier of the base station 112, an identifier of the service, a user subscription level corresponding to the user equipment, and one or more power thresholds for the service.

The identifier of the base station (gNB ID) is used to identify the base stations within a Public Land Mobile Network or connected to the AMF entity 108. The gNB ID is contained within New Radio cell Identity (NCI) of its cells. It is defined in 3GPP TS 38.300 and 38.413 (clause 9.3.1.6). Datatype of this parameter is BIT STRING of size 22-32 bits.

The identifier of the service refers to 5G QoS Identifier (5QI) value, i.e., a set of QoS characteristics that should be used for the QoS flow, of the service. It is an unsigned integer defined in 3GPP 23.501, clause 5.7.4. It can have values from 1 to 86 (as defined in 3GPP 23.501, version 16.6.0).

The user subscription level corresponding to the user equipment refers to premium, normal, or best effort based on the subscription taken of a user.

Further, the one or more power thresholds for the service may include a maximum energy rating and a minimum energy rating. The maximum energy rating refers to maximum power consumed by a particular base station for the service. Size of the parameter maximum energy rating is 4 bits. The minimum energy rating refers to minimum power consumed by the particular base station for the service. Size of the parameter maximum energy rating is 4 bits. Further, it may be appreciated that the energy rating is converted from Watts to Bits. Size of this data is 4 bits.

For identification of power consumed for transmitting number of bits, assuming power amplifier efficiency corresponding to a base station is 30%.
Maximum power local area BS=24 dBm=250 mW (approx)
Maximum energy service is taking=(20%) of the total power=0.2*250*0.3=15 mW
As size of the maximum energy credit is 4 bits=(250)/16=16 (approx)
So, 0000 represents power between (0 to 16 mW)
0001 represents power between (16 mW to 32 mW)
1111 represents power between (234 mW to 250 mW)

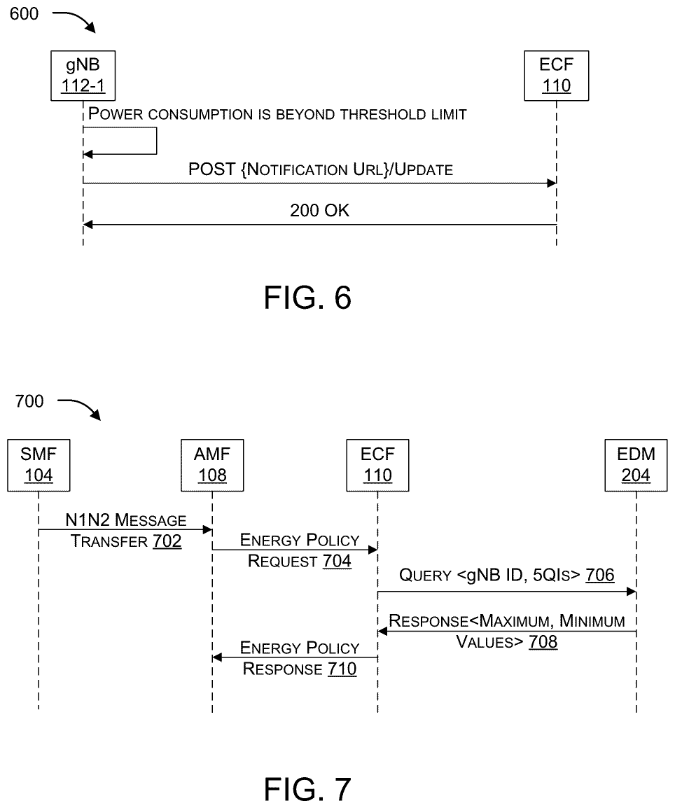

In some embodiments, connection between the ECF entity 110 and the base station 112-1 may be a NETCONF session or HTTPs based session, which will be discussed below with reference to FIGS. 5 and 6.

FIG. 5 illustrates a sequence flow diagram of an example method 500 between a base station 112-1 and an ECF entity 110 with a NETCONF-based session, in accordance with an embodiment of the present disclosure.

Referring to the method 500 of FIG. 5, in NETCONF, initially a Secure Shell (SSH) connection is established between the base station 112-1 and the ECF entity 110. After that, initial “hello” messages are exchanged. Further, Yet Another Next Generation (YANG) models are exchanged between the base station 112-1 and the ECF entity 110. The structure of the YANG models contain the set of network-monitored parameters that are exchanged between the base station 112-1 and the ECF entity 110. In some embodiments, the ECF entity 110 has a subscription with the base station 112-1 such that any update in the parameters triggers a notification to the ECF entity 110 and updates the parameters with the ECF entity 110. For example, a trigger notification comprising an updated set of parameters may be received by the ECF entity 110 from the base station 112-1 such that the ECF entity 110 may dynamically update a power policy based at least on the updated set of parameters.

FIG. 6 illustrates a sequence flow diagram of an example method 600 between a base station 112-1 and an ECF entity 110 with an HTTPs protocol-based session, in accordance with an embodiment of the present disclosure.

Referring to the method 600 of FIG. 6, in HTTP protocol, initially a Transmission Control Protocol (TCP) session is established between the base station 112-1 and the ECF entity 110. The base station 112-1 puts POST request for sending the set of power parameters to the ECF entity 110. The base station 112-1 may have an internal trigger when energy consumption is above a threshold. The base station 112-1 may POST a message whose payload consists of energy monitoring data structure and may update the network-monitored parameters such as, but not limited to, the identifier of the base station 112-1, the identifier of the service, the power thresholds, and the like.

FIG. 7 illustrates a sequence flow diagram of an example method 700 between AMF entity 108 and ECF entity 110, in accordance with an embodiment of the present disclosure.

When the AMF entity 108 is enforcing power policy, procedure described in 3GPP TS 23.502, clause 4.3.2 is same until the Namf_Communication_N1N2MessageTransfer to the AMF 108 from the SMF entity 104 (refer step 702). At step 704, the AMF entity 108 identifies an identifier of a base station (i.e., gNB ID) and extracts 5QI indexes from all the services provided in the PDU session given in N2 Session Management (SM) information message that is present in Namf_N1N2MessageTransfer. Further, the AMF entity 108 may send a request for a power policy for the given identifier of the base station and 5QI values to the ECF entity 110. At step 706, based on the identifier of the base station, the ECF entity 110 sends a query for maximum and minimum power consumption values to an energy database manager 204. At step 708, the ECF entity 110 may receive the maximum and minimum power consumption values from the energy database manager 204. The ECF entity 110 (or the policy determination unit 202) may determine a power policy for the base station for accommodating the service.

At step 710, the AMF entity 108 may receive an energy policy response from the ECF entity 110. The energy policy response may include the power policy that consists of maximum and minimum power consumption values for each service (5QI value). The AMF entity 108 modifies the N2 SM message in the Namf_N1N2MessageTransfer by including the power policies shared by the ECF entity 110 to the AMF entity 108 for that particular identifier of the base station. The base station receives this updated N2 message.

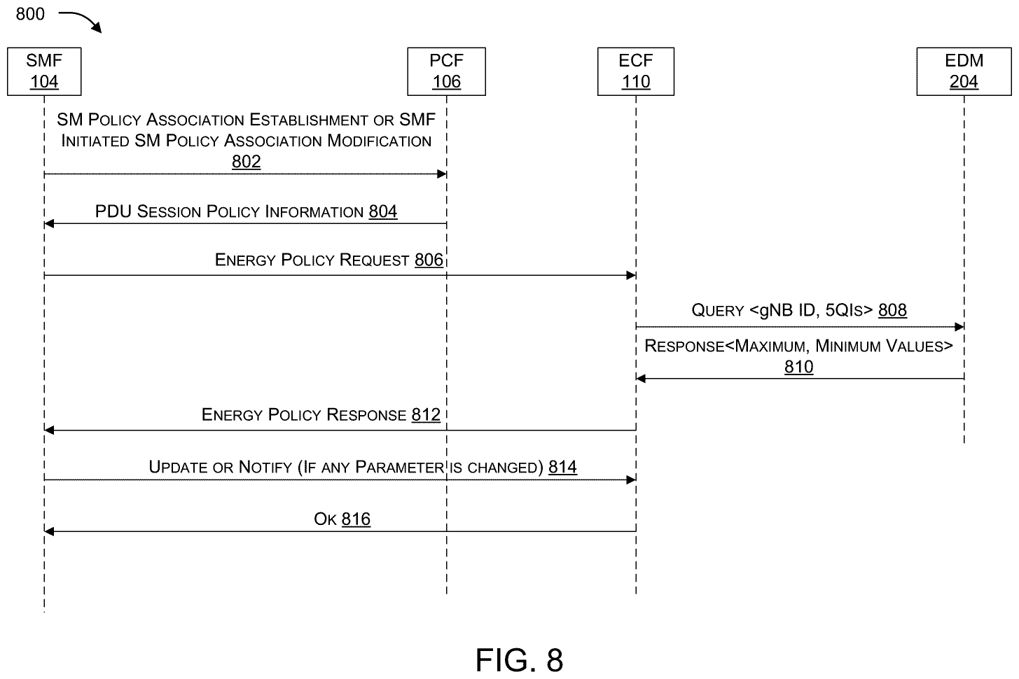

FIG. 8 illustrates a sequence flow diagram of an example method 800 between SMF entity 104 and ECF entity 110, in accordance with an embodiment of the present disclosure.

When the SMF entity 104 is enforcing power policy, procedure described in 3GPP TS 23.502, clause 4.3.2 until SMF selection is same. The message Nsmf_PDUSession_CreateSMContext request is modified by adding an identifier of base station (i.e., gNB ID) to it. Therefore, the new parameters in the updated message is as follows:
Nsmf_PDUSession_CreateSMContext Request (SUPI, DNN, S-NSSAI(s), PDU Session ID, AMF ID, gNB ID, Request Type, PCF ID, Priority Access, N1 SM container (PDU Session Establishment Request), User location information, Access Type, PEI, GPSI, UE presence in LADN service area, Subscription for PDU Session Status Notification, DNN Selection Mode, Trace Requirements)

Referring to FIG. 8, at step 802, the SMF entity 104 sends a request for getting PDU session related policy to the PCF entity 106. At step 804, the PCF entity 106 sends PDU session policy information to the SMF entity 104, i.e., 5QI values present for the PDU session.

At step 806, the SMF entity 104 sends an energy policy request to the ECF entity 110. At step 808, the ECF entity 110 sends a query comprising the identifier of the base station, gNB ID and 5QI to an energy database manager 204. At step 810, the energy database manager 204 sends maximum and minimum power consumption values to the ECF entity 110. The ECF entity determines a power policy for the service by the base station.

At step 812, the ECF entity 110 sends the power policy for different services to the SMF entity 104. The SMF entity 104 may include these power policies in the Namf_N1N2MessageTransfer. Then, same procedure as mentioned in 3GPP TS 23.502, clause 4.3.2 is continued. Referring to FIG. 8, at step 814, the SMF entity 104 may determine an update in a set of network-monitored parameters and update or notify the same to the ECF entity 110. At step 816, the ECF entity 110 may acknowledge the receipt of the updated set of network-monitored parameters, and dynamically update the power policy accordingly.

In accordance with embodiments of the present disclosure, the procedure defined in 3GPP TS 23.502, section 4.3.2 is performed as the PCF entity 106 gets the power policy information from Unified Data Management (UDM) entity, and binds the policy rules together to form power policy.

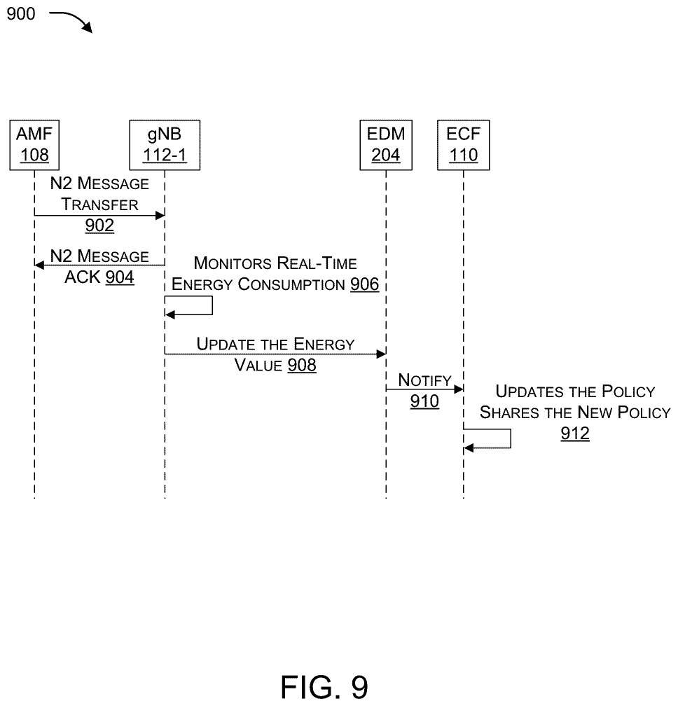

FIG. 9 illustrates a sequence flow diagram of an example method 900 between a base station 112-1 and an energy database manager 204, in accordance with an embodiment of the present disclosure.

In some embodiments, the AMF entity 108 has a candidate cell list and 5QI index of services. The AMF entity 108 queries the ECF entity 110 for energy-related information to select the best possible base station for a service to a particular user equipment. The AMF entity 108 may have all the energy-related parameters as shown in Table 2 below.

TABLE 2

| | Maximum | Minimum | | Rated | PA |
|---|---|---|---|---|---|
| gNB ID | Value | Value | gNB class | Power | efficiency |
| A | 0011 | 0000 | 1 | 46 dBm | 30% |
| B | 1010 | 0001 | 2 | 38 dBm | 20% |
| C | 1111 | 0100 | 3 | 24 dBm | 25% |

In some embodiments, the AMF entity 108 calculates power for that particular service in different base stations 112.

$$Power computation = Rated power * ( Maximum Value / 16 ) * PA\_efficiency$$

Here, Rated power—Rated power of the base station in Watts
Maximum Value—Bits converted to decimal
PA_efficiency—Power Amplifier efficiency in the above Table 2.

According to Table 2 above, base station A maximum power range is in (1.5 W, 2.25 W), base station B maximum power range is in (0.6 W, 0.675 W), and base station C maximum power range is in (58.5 W, 62.5 mW).

In some embodiments, according to user subscription level and service required, the AMF entity 108 may assign an appropriate base station 112. If the user subscription level is “Premium,” the AMF entity 108 may assign base station A, as premium may have less energy constraint. If user were availing emergency services or Guaranteed Bit Rate (GBR) services, then the AMF entity 108 may assign base station A (because of high priority). If the user subscription level is “Normal” and not availing GBR services, the AMF entity 108 may assign base station B or C based on better power amplifier efficiency. As per Table 2 above, the AMF entity 108 may assign base station C as power amplifier efficiency is high. If the user subscription level is “Best Effort” and not availing GBR services, the AMF entity 108 may assign base station C to optimize the energy.

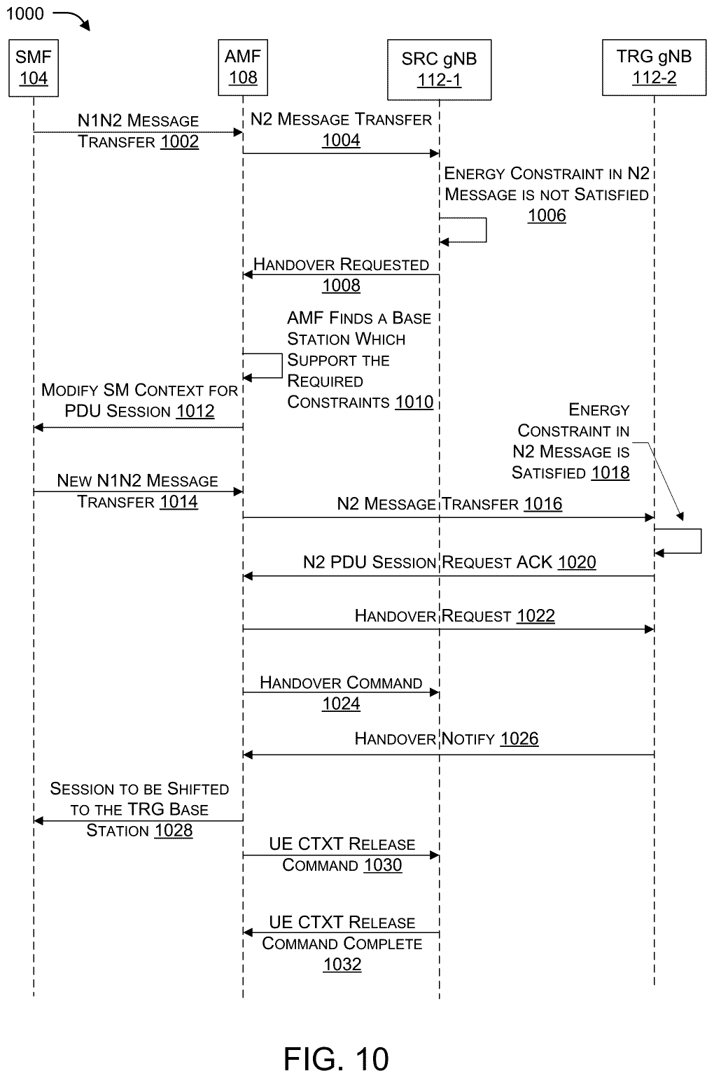

Referring to FIG. 9, at step 902, the base station 112-1 receives power policy from the AMF entity 108 for energy efficiency per services. At step 904, the base station 112-1 sends an acknowledgement for the same to the AMF entity 108. At step 906, after receiving the power policy, the base station 112-1 performs analytics based on a historical pattern of power consumption for the service to identify whether the base station 112-1 can accommodate the service within permissible energy limits. If the base station 112-1 identifies that the service can be accommodated within the permissible energy limits, the base station 112-1 sends an acknowledgment through the N2 message (refer step 1004). If not, the base station 112-1 may transmit a negative acknowledgment (i.e., handover request) to the upper layer (i.e., core network 102), which is explained with reference to FIG. 10.

Referring to FIG. 9, if the base station 112-1 sends the acknowledgement through the N2 message, the base station 112-1 may schedule the services for that PDU session and an energy monitoring unit 114-1 in the base station 112-1 may monitor real-time power consumption value according to the power policy. If the real-time power consumption value is in the given range, the base station 112-1 may continue to monitor the real-time power consumption value. If the real-time power consumption value is not as per the power policy, the base station 112-1 may have three different power policies based on the user subscription level of user associated with a user equipment. As discussed herein, a service provider may classify users into three types, i.e., Premium, Normal, and Best Effort. In some embodiments, the network allows premium users to continue availing the service until a threshold value (x) greater than the energy limit defined in the power policy. In some other embodiments, the network allows normal users to continue availing the service and informs the users that extra charging method may be applied for increasing the energy limit. In some other embodiments, the network stops the service for best effort users and informs the upper layers to initiate handover of the service from the base station 112-1.

Referring to FIG. 9, at step 908, the base station 112-1 updates the set of parameters and notifies the same to the energy database manager 204. At step 910, the energy database manager 204 notifies the updated set of parameters to the ECF entity 110. At step 912, the ECF entity 110 updates the power policy based on the updated set of parameters, and shares the updated power policy with the base station 112-1 via the AMF entity 108.

In some embodiments, if the base station 112-1 sends the negative acknowledgement to the AMF entity 108 via the N2 message due to energy constraint, the AMF entity 108 may initiate a handover procedure, as discussed with reference to FIG. 10.

FIG. 10 illustrates a sequence flow diagram of an example method 1000 of N2 handover, in accordance with an embodiment of the present disclosure.

Referring to FIG. 10, at step 1002, Namf_Communication_N1N2MessageTransfer is communicated by the SMF entity 104 to the AMF entity 108. At step 1004, the AMF entity 108 sends N2 PDU session request message to a source base station 112-1. At step 1006, the source base station 112-1 checks with energy monitoring unit 114-1 to determine whether it can provide a service to a user equipment with given energy constraints. At step 1008, if the source base station 112-1 cannot provide the service to the user equipment, then a handover request message is sent to the AMF entity 1108.

At step 1010, the AMF entity 108 selects another base station (e.g., 112-2) that can support the signalled target identifier from the base station 112-2. In some embodiments, the AMF entity 108 rejects the handover request message when the AMF entity 108 cannot find the base station. In some other embodiments, at step 1012, when the AMF entity 108 selects a target base station 112-2, the AMF entity 108 creates a modification request and sends it to the SMF entity 104. The SMF entity 104 analyzes the target identifier and takes appropriate actions. The SMF entity 104 does the PCF selection and updates the policies. The SMF entity 104 does UPF selection and updates N4 session between the SMF entity 104 and new UPF. At step 1014, new Namf_Communication_N1N2MessageTransfer is communicated to the AMF entity 108.

At step 1016, the AMF entity 108 sends N2 message to the target base station 112-2. At step 1018, the target base station 112-2 checks with an energy monitoring unit 114-2 to determine whether it can provide the service to the user equipment with the given energy constraints. At step 1020, if the target base station 112-2 determines that it can provide the service to the user equipment, then the target base station 112-2 sends a N2 PDU session request acknowledgement to the AMF entity 108. In some other embodiments, if the target base station 112-2 determines that it cannot provide the service to the user equipment, then the target base station 112-2 may send a negative acknowledgment to the AMF entity 108. In such a scenario, the AMF entity 108 may either determine another base station or reject the handover request message received from the source base station 112-1. At step 1022, in response to receiving the N2 PDU session request acknowledgment, a handover request is sent from the AMF entity 108 to the target base station 112-2.

At step 1024, the AMF entity 108 builds a handover command message and sends it to the source base station 112-1. At step 1026, a handover notify message is sent from the target base station 112-2 to the AMF entity 108. At step 1028, the AMF entity 108 constructs a SM context modify request to inform the SMF entity 104 that the handover is complete. The SMF entity 104 responds to the update, and the handover procedure ends. At step 1030, the source base station 112-1 receives a user equipment context release command. If there are PDU sessions that fail to setup at the target base station 112-2 are now released at the SMF entity 104. At step 1032, a user equipment release command complete message is sent from the source base station 112-1 to the AMF entity 108.

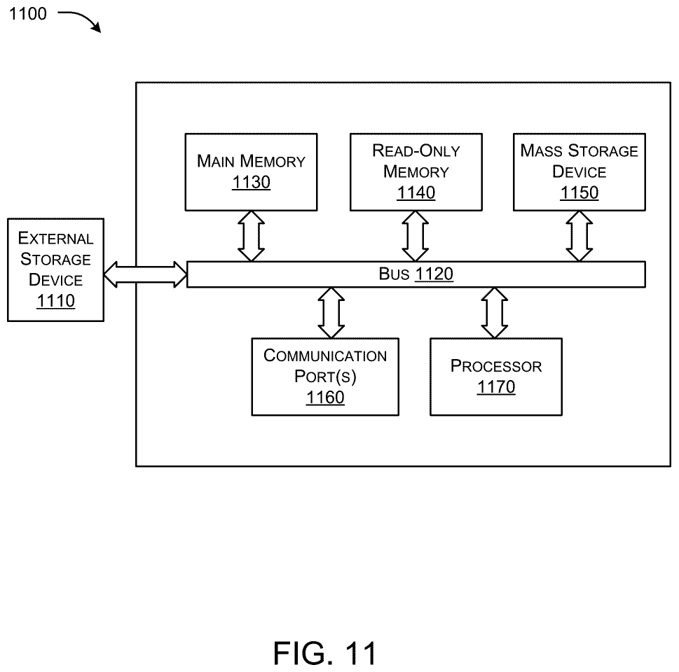

The methods and techniques described here may be implemented in digital electronic circuitry, field programmable gate array (FPGA), or with a programmable processor (for example, a special-purpose processor or a general-purpose processor such as a computer) firmware, software, or in combinations of them. Apparatus embodying these techniques may include appropriate input and output devices, FPGA, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system, explained in detail with reference to FIG. 11, including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), and flash memory devices; magnetic disks such as internal hard disks and removable disks; and magneto-optical disks. Any of the foregoing may be supplemented by, or incorporated in, specially designed application-specific integrated circuits (ASICs).

In particular, FIG. 11 illustrates an exemplary computer system 1100 in which or with which embodiments of the present disclosure may be utilized. The computer system 1100 may be implemented as or within the core network, any network entity of the core network, or base station described in accordance with embodiments of the present disclosure.

As depicted in FIG. 11, the computer system 1100 may include an external storage device 1110, a bus 1120, a main memory 1130, a read-only memory 1140, a mass storage device 1150, communication port(s) 1160, and a processor 1170. A person skilled in the art will appreciate that the computer system 1100 may include more than one processor 1170 and communication ports 1160. The processor 1170 may include various modules associated with embodiments of the present disclosure. The communication port(s) 1160 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 1160 may be chosen depending on a network, such a Local Area Network (LAN), Wide Area Network (WAN), or any network to which the computer system 1100 connects.

In an embodiment, the main memory 1130 may be Random Access Memory (RAM), or any other dynamic storage device commonly known in the art. The read-only memory 1140 may be any static storage device(s) e.g., but not limited to, a Programmable Read Only Memory (PROM) chips for storing static information e.g., start-up or basic input output system (BIOS) instructions for the processor 1170. The mass storage device 1150 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus 1120 communicatively couples the processor 1170 with the other memory, storage, and communication blocks. The bus 1120 may be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 1170 to the computer system 1100.

In another embodiment, operator and administrative interfaces, e.g., a display, keyboard, and a cursor control device, may also be coupled to the bus 1120 to support direct operator interaction with the computer system 1100. Other operator and administrative interfaces may be provided through network connections connected through the communication port(s) 1160. Components described above are meant only to exemplify various possibilities. In no way should the aforementioned exemplary computer system 1100 limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure provides an efficient solution for service-based optimization of energy policy enforcement at a base station.

The present disclosure facilitates an energy optimization function for a base station for providing a particular service to a user equipment considering power consumption, traffic load, etc. as key parameters.

The present disclosure provides a mechanism for service-based optimization of base station based on resource utilization.

I/We claim:

1. A method for power policy enforcement in an access network, comprising:
receiving (302), by a processor associated with a core network (102), a set of network-monitored power parameters from a base station (112-1) in the access network, the set of network-monitored power parameters corresponding to a service associated with a user equipment served by the base station (112-1) in the access network;
determining (304), by the processor, a power policy corresponding to the service associated with the user equipment based at least on the set of network-monitored power parameters; and
transmitting (306), by the processor, via one or more network entities of the core network (102), the power policy to the base station (112-1) for enforcement of the power policy at the base station (112-1).

2. The method as claimed in claim 1, wherein determining (304), by the processor, the power policy comprises determining, by the processor, the power policy further based on historical power parameters, workload, and user subscription level corresponding to the user equipment.

3. The method as claimed in claim 1, wherein receiving (302), by the processor, the set of network-monitored power parameters comprises receiving, by the processor, the set of network-monitored power parameters via one of: Network Configuration (NETCONF) protocol-based interface, or HyperText Transfer Protocol Secure (HTTPs) protocol-based interface.

4. The method as claimed in claim 1, comprising:
receiving, by the processor, a trigger notification comprising an updated set of network-monitored power parameters from the base station (112-1); and
dynamically updating, by the processor, the power policy based at least on the updated set of network-monitored power parameters.

5. The method as claimed in claim 1, comprising:
transmitting, by the processor, a request to the base station (112-1) to obtain a maximum power consumption value and a minimum power consumption value for the service, wherein the request comprises at least one of: an identifier of the base station (112-1), and an identifier of the service; and
receiving, by the processor, the maximum power consumption value and the minimum power consumption value from the base station (112-1) for the service.

6. The method as claimed in claim 1, wherein the one or more network entities comprise Access and Mobility Management Function (AMF) entity (108), Session Management Function (SMF) entity (104), and Policy Control Function (PCF) entity (106).

7. The method as claimed in claim 6, wherein the transmitting (306) comprises transmitting, by the processor, via the AMF entity (108), the power policy to the base station (112-1), and wherein the method comprises:
receiving, by the AMF entity (108), an acknowledgement for accommodating the service according to the power policy from the base station (112-1); or
receiving, by the AMF entity (108), a negative acknowledgment from the base station (112-1).

8. The method as claimed in claim 7, wherein in case of the negative acknowledgement, the method comprises:
determining, by the AMF entity (108), another base station (112-2) for accommodating the service based on the power policy; and
initiating, by the AMF entity (108), a handover of the user equipment from the base station (112-1) to the another base station (112-2) for the enforcement of the power policy at the another base station (112-2).

9. The method as claimed in claim 8, wherein determining, by the AMF entity (108), the another base station (112-2) comprises:
calculating, by the AMF entity (108), a power consumption value by each of a plurality of base stations (112) in the access network for accommodating the service, wherein the power consumption value by said each of the plurality of base stations (112) is based on at least one of: a rated power of a given base station, a maximum power consumption by the given base station for the service, and a power amplifier efficiency corresponding to the given base station; and
assigning, by the AMF entity (108), the another base station (112-2) for accommodating the service based at least on the power consumption value and a user subscription level corresponding to the user equipment.

10. The method as claimed in claim 8, wherein initiating, by the AMF entity (108), the handover of the user equipment from the base station (112-1) to the another base station (112-2) comprises:
transmitting, by the AMF entity (108), the power policy corresponding to the service to the another base station (112-2); and
receiving, by the AMF entity (108), an acknowledgement for accommodating the service according to the power policy from the another base station (112-2), or receiving, by the AMF entity (108), a negative acknowledgment from the another base station (112-2).

11. The method as claimed in claim 6, comprising:
receiving, by the processor, a request for the power policy from the SMF entity (104) corresponding to the service; and
transmitting, by the processor, the power policy to the SMF entity (104) in response to the request based on an identifier of the base station (112-1),
wherein the transmitting (306) the power policy to the base station (112-1) comprises transmitting, by the processor, via the SMF entity (104), the power policy to the base station (112-1).

12. The method as claimed in claim 1, wherein the power policy comprises at least one of: an identifier of the power policy, an identifier of the base station (112-1), an identifier of the service, a user subscription level corresponding to the user equipment, and one or more power thresholds for the service.

13. The method as claimed in claim 1, wherein the set of network-monitored power parameters comprises at least one of: an identifier of the base station (112-1), an identifier of the service, a user subscription level corresponding to the user equipment, a maximum power consumption by the base station (112-1) for the service, a minimum power consumption by the base station (112-1) for the service, a class of the base station (112-1), a rated power of the base station (112-1), and a power amplifier efficiency corresponding to the base station (112-1).

14. The method as claimed in claim 1, wherein the power policy comprises one or more power thresholds for the service, such that for the enforcement of the power policy at the base station (112-1), an estimated power consumption value for the service for a pre-defined time interval is within the one or more power thresholds.

15. A network entity (108) in a core network (102) for power policy enforcement, comprising:
a processor; and
a memory operatively coupled with the processor, wherein the memory comprises processor-executable instructions which, when executed, cause the processor to:
transmit a request for a power policy corresponding to a service associated with a user equipment in an access network to another network entity (110) in the core network (102);
receive the power policy corresponding to the service associated with the user equipment from the another network entity (110), the power policy being based at least on a set of network-monitored power parameters;
determine a power consumption value by each of a plurality of base stations (112) in the access network for accommodating the service based on the power policy;
assign a base station (112-1) of the plurality of base stations (112) based at least on the power consumption value and a user subscription level corresponding to the user equipment; and
transmit the power policy to the base station (112-1) for enforcing the power policy.

16. A network entity (104) in a core network (102) for power policy enforcement, comprising:
a processor; and
a memory operatively coupled with the processor, wherein the memory comprises processor-executable instructions which, when executed, cause the processor to:
transmit a request for a power policy corresponding to a service associated with a user equipment served by a base station (112-1) in an access network to another network entity (110) in the core network (102);
receive the power policy corresponding to the service associated with the user equipment from the another network entity (110), the power policy being based at least on a set of network-monitored power parameters;
transmit the power policy to the base station (112-1) for enforcing the power policy;
determine an update in the set of network-monitored power parameters corresponding to the service; and
transmit the updated set of network-monitored power parameters to the another network entity (110) for dynamically updating the power policy corresponding to the service.
